(19) United States
(12) Patent Application Publication
(10) Pub. No.: US 2006/0017310 A1
(43) Pub. Date: Jan. 26, 2006

(54) Apparatus for supporting cowl cross member

(76) Inventors: Jae Kap Joo, Seoul (KR); Ki Chang Kim, Suwon-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/185,362

(22) Filed: Jul. 20, 2005

(30) Foreign Application Priority Data
Jul. 20, 2004 (KR) 10-2004-0056557

(51) Int. Cl. B60J 7/00

(52) U.S. Cl. 296/193.02

(57) ABSTRACT

In a support for a cowl cross member the strength of a floor panel can be enhanced, and, when the vehicle is in an idle state, driver comfort can be increased because a vibration is reduced.

### CROSS-REFERENCE TO RELATED APPLICATION

This application claims priority to and the benefit of Korean Patent Application 10-2004-0056557 filed in the Korean Intellectual Property Office on Jul. 20, 2004, the entire content of which is incorporated herein by reference.

### BACKGROUND OF THE INVENTION

(a) Field of the Invention

The present invention relates to an apparatus for supporting a cowl cross member. More particularly, the present invention relates to the apparatus for supporting the cowl cross member that can increase occupant and, in particular, driver comfort by reducing vehicle vibration when the vehicle is in an idle state.

(b) Description of the Related Art

In a typical cowl support, a bracket is connected to a reinforcing member with a lower portion of a cowl cross member connected to that bracket. However, there can be disadvantages in driver comfort because vibration occurs at the steering column due to movement of the cowl cross member when the vehicle is in an idle state.

Furthermore, a problem can also occur in that the supporting strength of prior art arrangements can be less than required. A further problem occurs in that the cost of manufacture becomes high since a center support must be relatively thick to ensure that the bracket is strongly connected to the floor panel.

The above information disclosed in this Background section is only for enhancement of understanding of the background of the invention and therefore, it may contain information that does not form the prior art that is already known in this country to a person of ordinary skill in the art.

### SUMMARY OF THE INVENTION

Embodiments of the present invention provide an apparatus for supporting a cowl cross member having advantages of enhanced strength.

An exemplary apparatus for supporting the cowl cross member according to an exemplary embodiment of the present invention includes a floor panel defining an upper surface of a tunnel, a mounting unit defining a lower surface of the tunnel and mounted to the floor panel such that the mounting unit can support the floor panel, a reinforcing member mounted to the floor panel such that the reinforcing member can support an upper surface of the floor panel, and a supporting unit mounted to the reinforcing member and the floor panel such that the supporting unit supports the cowl cross member.

The mounting unit includes an upper stay supporting an interior surface of the tunnel and a lower surface of the floor panel and a lower stay supporting a lower surface of the upper stay.

The supporting unit includes an upper member mounted to an upper surface of the reinforcing member such that the upper member supports the reinforcing member, and side members mounted to the upper member and the floor panel such that the side members support the cowl cross member.

### BRIEF DESCRIPTION OF THE DRAWINGS

FIG. 1 shows a state where a cowl cross member is mounted according to an exemplary embodiment of the present invention.

FIG. 2 is an enlarged view showing a portion B of FIG. 1.

FIG. 3 is a sectional view of FIG. 2 along a line V-V.

### DETAILED DESCRIPTION OF THE EMBODIMENTS

An embodiment of the present invention will hereinafter be described in detail with reference to the accompanying drawings.

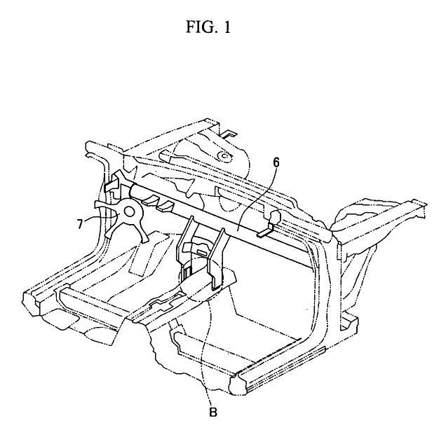

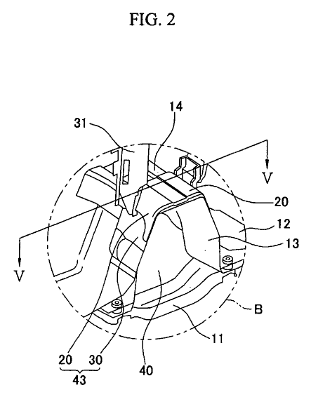

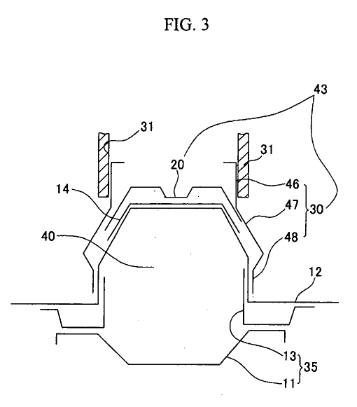

Referring to FIG. 1, according to an exemplary embodiment of the present invention, an apparatus for supporting the cowl cross member 6 supports the cowl cross member 6 from under the cowl cross member 6. As shown in FIG. 2 and FIG. 3, according to an exemplary embodiment of the present invention an apparatus for supporting the cowl cross member 6 includes a floor panel 12, mounting unit 35, reinforcing member 14, and supporting unit 43.

The floor panel 12 defines an upper surface of a tunnel 40, and a mounting unit 35 defines a lower surface of the tunnel 40 and is mounted to the floor panel 12 such that the mounting unit 35 can support the floor panel 12. The reinforcing member 14 is mounted to the floor panel 12 such that the reinforcing member 14 can support an upper surface of the floor panel 12 and a supporting unit 43 is mounted to the reinforcing member 14 and the floor panel 12 such that the supporting unit 43 supports the cowl cross member 6. That is, the floor panel 12 defines an upper surface of the tunnel 40 and the mounting unit 35 defines the lower surface of the tunnel 40.

In addition, the mounting unit 35 supports the floor panel 12. Further, the reinforcing member 14 supports the floor panel 12 by being mounted to the upper surface of the floor panel 12 defining an upper surface of the tunnel 40. Thus, the reinforcing member 14 can enhance the strength of the floor panel 12.

The mounting unit 35 includes an upper stay 13 and a lower stay 11. The upper stay 13 supports an interior surface of the tunnel 40 and a lower surface of the floor panel 12, and the lower stay 11 supports a lower surface of the upper stay 13. Therefore, the tunnel 40 is formed by the floor panel 12 and the mounting unit 35. Strength of the floor panel 12 is enhanced by connecting the mounting unit 35 with the floor panel 12. A supporting unit 43 includes an upper member 20 and side members 30.

Referring to FIG. 3, an upper member 20 is mounted to the upper surface of the reinforcing member 14 such that the upper member 20 supports the reinforcing member 14, and the side members 30 are mounted to the upper member 20 and the floor panel 12 such that the side members 30 support the cowl cross member 6. The side members 30 include upper portions 46, middle portions 47, and lower portions 48. That is, the reinforcing member 14, the upper member 20, and the side members 30 are successively mounted to the upper surface of the floor panel 12 defining the upper surface of the tunnel 40.

According to an exemplary embodiment of the present invention, because the reinforcing member 14, the upper member 20, and the side members 30 are mounted as described, when the vehicle is in an idle state, vibration occurring in the vehicle body is prevented from being transmitted to a steering column 7 through the cowl cross member 6.

In a preferred embodiment, a width of the upper member 20 is formed such that it is similar to the width of the reinforcing member 14. Lower portions 31 of the cowl cross member 6 are connected to upper portions 46 of the side members 30. In addition, middle portions 47 of the side members 30 are connected to the upper member 20 and lower portions 48 are connected to the floor panel 12. The side members 30 are connected to the upper member 20 and the floor panel 12 such that the side members 30 support the cowl cross member 6. Furthermore, because the side members 30 are simultaneously connected to the upper member 20 and the floor panel 12, a supporting force of the floor panel 12 and the upper member 20 can be enhanced.

According to the cowl cross member 6 of an exemplary embodiment of the present invention, because the mounting unit 35 and the supporting unit 20, 30 are connected to the floor panel in a plurality of places, vibration that occurs when the vehicle is in an idle state is prevented from being transmitted to the steering column. Furthermore, because the reinforcing member 14, the upper member 20, and the side members 30 are connected to the floor panel 12, the cowl cross member 6 can be supported more strongly. In addition, according to an exemplary embodiment of the present invention, although the reinforcing member 14 is not thick, the reinforcing member 14 can strongly support the cowl cross member 6, and therefore cost of manufacture can be reduced.

While this invention has been described in connection with what is presently considered to be a practical exemplary embodiment, it is to be understood that the invention is not limited to the disclosed exemplary embodiment, but, on the contrary, is intended to cover various modifications and equivalent arrangements included within the spirit and scope of the appended claims.

What is claimed is:

1. An apparatus for supporting a cowl cross member comprising:
a floor panel defining an upper surface of a tunnel;
a mounting unit defining a lower surface of the tunnel and mounted to the floor panel such that the mounting unit supports the floor panel;
a reinforcing member mounted to the floor panel such that the reinforcing member supports an upper surface of the floor panel; and
a supporting unit mounted to the reinforcing member and the floor panel such that the supporting unit supports the cowl cross member.

2. The apparatus of claim 1, wherein the mounting unit comprises:
an upper stay supporting an interior surface of the tunnel and a lower surface of the floor panel; and
a lower stay supporting a lower surface of the upper stay.

3. The apparatus of claim 1, wherein the supporting unit comprises:
an upper member mounted to an upper surface of the reinforcing member such that the upper member supports the reinforcing member; and
side members mounted to the upper member and the floor panel such that the side members support the cowl cross member.
